(19) United States
(12) Patent Application Publication
(10) Pub. No.: US 2026/0210175 A1
(43) Pub. Date: Jul. 23, 2026

(54) DOUBLE OPENING PET DOOR

(71) Applicant: Cixi Xingan Industry Co., Ltd., Cixi (CN)

(72) Inventor: GUOXING YAO, Cixi (CN)

(21) Appl. No.: 19/570,963

(22) Filed: Mar. 18, 2026

(30) Foreign Application Priority Data
Mar. 27, 2025 (CN) 202520552362.5

(51) Int. Cl. E06B 7/32

(52) U.S. Cl. CPC E06B 7/32

(57) ABSTRACT

Provided is a double opening pet door, which includes a connection frame, the connection frame is connected to a movable door, and the movable door is provided with a movable pet door; the movable door is further provided with a pet lock pin configured to restrict an opening of the pet door. The connection frame is connected to the movable door through a pin body, the connection frame is provided with fitting grooves, the connection frame is connected to the pin body through the fitting groove; two sides of the movable door are provided with the fitting grooves, and the pin body cooperates with the fitting grooves to enable the movable door to rotate in two directions and flexibly adjust an installation direction. By adjusting the height, the movable door can adapt to different door frames, and the installation is convenient without the need to modify the original door.

### CROSS-REFERENCE TO RELATED APPLICATIONS

This application claims priority to Chinese Patent Application No. 202520552362.5, filed on Mar. 27, 2025, which is hereby incorporated by reference in its entirety.

### TECHNICAL FIELD

The present disclosure relates to the field of pet door technologies, and in particular, to a double opening pet door.

### BACKGROUND

There are significant limitations in the existing design of pet doors. Currently, pet doors on the market usually require separate installation with the door, which requires users to make additional modifications or treatments to the door during installation. This not only increases the difficulty and cost of installation but also may cause certain damage to the structure of the door itself. Another way is to reserve a dedicated position during the manufacturing process of the door to install the pet door. Although this method simplifies the installation process to a certain extent, it is not applicable to already installed doors. Besides that, this reserved position door lacks universality and can only be used for specific pet door styles. More importantly, most existing pet door designs only consider the entry and exit needs of pets, without integrating the usage needs of people and pets. In real life, people and pets often need to enter and exit through the same door, and existing pet doors cannot meet the need for flexible and convenient sharing of the same door structure, which brings many inconveniences to users.

### SUMMARY

The purpose of the present disclosure is to provide a double opening pet door that can adapt to various installation scenarios and achieve integrated use of humans and pets to solve problems existing in the prior art. To achieve the above objectives, the specific technical solution of the present disclosure is: a double opening pet door, including: a connection frame, where the connection frame is connected to a movable door, and the movable door is provided with a movable pet door; the movable door is further provided with a pet lock pin configured to restrict an opening of the pet door.

In some embodiments of the present disclosure, the connection frame is connected to the movable door through a pin body, the connection frame is provided with fitting grooves, and the connection frame is connected to the pin body through the fitting groove; two sides of the movable door are provided with the fitting grooves, and the pin body cooperates with the fitting grooves to enable the movable door to rotate in two directions and flexibly adjust an installation direction; when the movable door is used as a left door, the connection frame is fixed to a left side of the door frame, and the pin body is fixed to the fitting grooves on the left side of the movable door through screws; when the movable door is used as a right door, the connection frame is fixed to a right side of the door frame, and the pin body is fixed to the fitting grooves on the right side of the movable door through the screws.

In some embodiments of the present disclosure, the pin body is composed of an upper pin and a lower pin, and both the upper pin and the lower pin are provided with pin holes; by threading the screws through the pin hole of the upper pin and fixing it on the matching hole, a connection between the connection frame and the pin body is completed; by threading the screw through the pin hole of the lower pin and fixing it on the matching hole, the connection between the movable door and the pin body is completed. The movable door is provided with a height adjustment system, and the height adjustment system includes an expansion piece, and the expansion piece is provided with a telescopic rod, a spring, and a snap spring inside; two ends of the telescopic rod extend from the expansion piece and is fixed by a locking knob.

In some embodiments of the present disclosure, the expansion piece is provided with a contact end, and when the contact end contacts with the connection frame, the telescopic rod abuts against the connection frame; when the telescopic rod is too long, the connection frame presses down on the telescopic rod, and the telescopic rod compresses the spring to adapt to a height of the connection frame; a required height of the telescopic rod is determined by pressing the locking knob against the telescopic rod.

In some embodiments of the present disclosure, upper and lower frames of the connection frame are each provided with locking knobs and locking rods, and rotating the locking knobs enables the locking rods to insert to the movable door profile; the movable door is formed by connecting the upper and lower movable doors through profiles, and both the upper and lower movable doors are provided with visual windows. The movable door is provided with a connection movable lock.

In some embodiments of the present disclosure, the connection movable lock includes a lock seat, a lock body is provided on the lock seat, a push locking position is provided on the lock body, and a connection screw body is provided on the lock body; a bolt in the connection screw body is connected to a screw, and the screw is provided with a lock head; the lock head is matched with a locking hook, and the locking hook is provided on the movable door locking position, the movable door locking position is fixed on other doors; when in use, the push locking position drives the connection screw body to move, so that the lock body rotates on the lock seat, and the lock head is configured to cooperate with the locking hook; during this period, a length of the screw is adjusted to fix the connection movable lock and other doors.

In some embodiments of the present disclosure, the connection movable lock includes a first fixed seat, and the first fixed seat is provided with a first connection hole, and the first fixed seat is fixed to the movable door through the first connection hole; the first fixed seat is provided with a lock core, and each surface of the lock core is provided with locking positions, namely a first locking position, a second locking position, and a third locking position; a second fixed seat is provided on a wall or a wall corner, and the second fixed seat is provided with a second connection hole; the second fixed seat is fixed to the wall or wall corner through the second connection hole; the second fixed seat is provided with a rotatable head, and the rotatable head is provided with a rotating locking hook, and the locking hook is coupled with the first locking position, the second locking position, or the third locking position.

The beneficial effects of the present disclosure are that, through the height adjustment system, the height of the movable door can be adjusted to adapt to different door frames, making installation convenient without the need to modify the original door. By using the locking knob and connection movable lock, safety is enhanced and the product can be used better. The pet lock pin controls the one-way opening of the pet door to prevent pets from accidentally coming out. The adjustable screw design of the connection movable lock adapts to different door spacing, thereby improving installation stability. The double open design combined with the visual window realizes the integrated use of people and pets, rendering it convenient to observe the situation of pets.

Other beneficial effects include the movable door being hinged to the connection frame through the pin body, with fitting grooves on two sides for an installation of the pin body. It is compatible with both left and right door opening modes, allowing a user to flexibly choose the opening direction according to the actual installation scenario, improving the universality and convenience of the product. At the same time, there is no need to produce left and right door products separately, reducing mold and production investment, and lowering production costs. The double opening movable door can be directly installed on the existing door body through hinges and connection frames, with strong universality, realizing the “integrated” use of people and pets. The movable door is assembled from profiles, easy to disassemble, and convenient for cleaning the interior or replacing components.

### BRIEF DESCRIPTION OF DRAWINGS

In order to provide a clearer explanation of the technical solution of the embodiments of the present disclosure, a brief introduction will be given to the accompanying drawings required for the embodiments. It is obvious that the drawings described below are only some embodiments of the present disclosure. For those skilled in the art, other drawings can be obtained based on these drawings without creative work.

FIG. 1 is a reference schematic diagram of an overall structural state of a first embodiment of the present disclosure.

FIGS. 2 and 3 are reference diagrams of usage state of the first embodiment of the present disclosure.

FIG. 4 is a schematic diagram of a state reference of a connection movable lock structure in the first embodiment of the present disclosure.

FIG. 5 is a reference schematic diagram of a locking knob structure state of the first embodiment of the present disclosure.

FIG. 6 is a schematic diagram of a structural state of an expansion piece according to the first embodiment of the present disclosure.

FIG. 7 is a reference structural schematic diagram of a pet door according to the first embodiment of the present disclosure.

FIG. 8 is a reference schematic diagram of a structure state of a movable lock in the first embodiment of the present disclosure.

FIG. 9 is a reference diagram of a usage state of a second embodiment of the present disclosure.

FIG. 10 is a reference diagram of the usage state of the second embodiment of the present disclosure.

FIG. 11 is a reference schematic diagram of a connection frame structure state of the second embodiment of the present disclosure.

FIG. 12 is a reference structural schematic diagram of the pet door in the second embodiment of the present disclosure.

FIG. 13 is a reference schematic diagram of a structure state of a pin body in the second embodiment of the present disclosure.

### DESCRIPTION OF EMBODIMENTS

Below, a detailed description of the embodiments of the present disclosure will be provided in combination with the accompanying drawings. Specific examples will be used to illustrate the disclosed embodiments, and those skilled in the art can easily understand other advantages and effects of the present disclosure from the content disclosed in this specification. Further explanation will be provided in combination with the accompanying drawings.

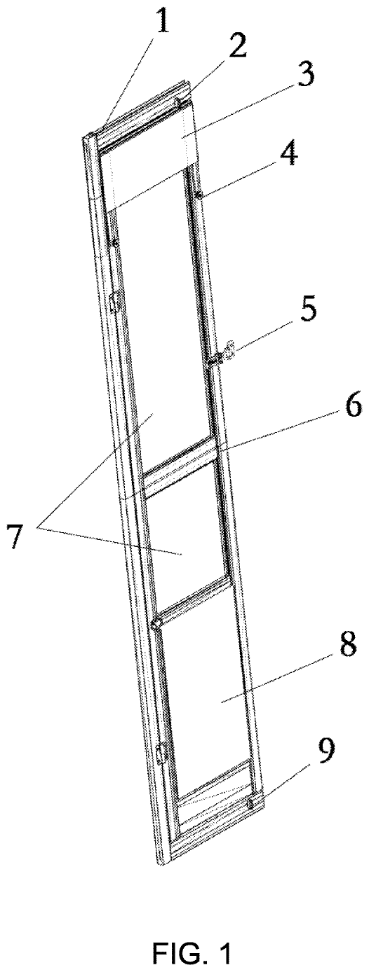

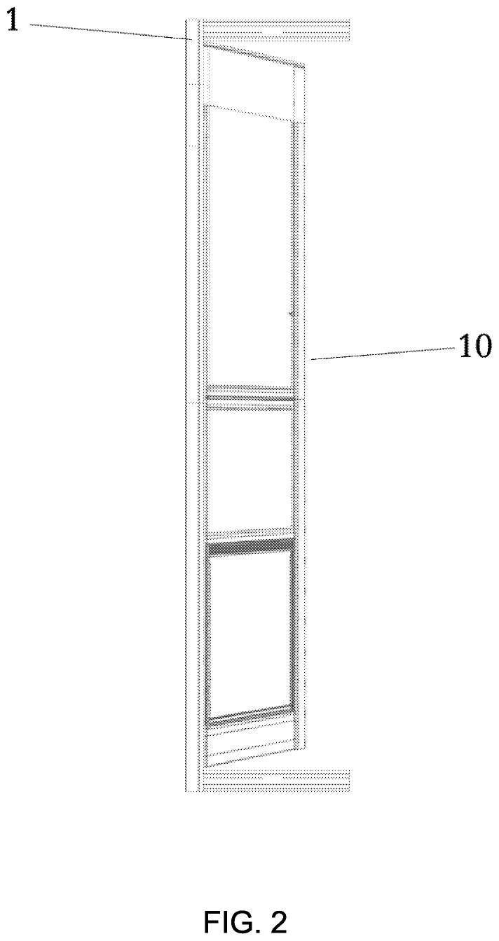

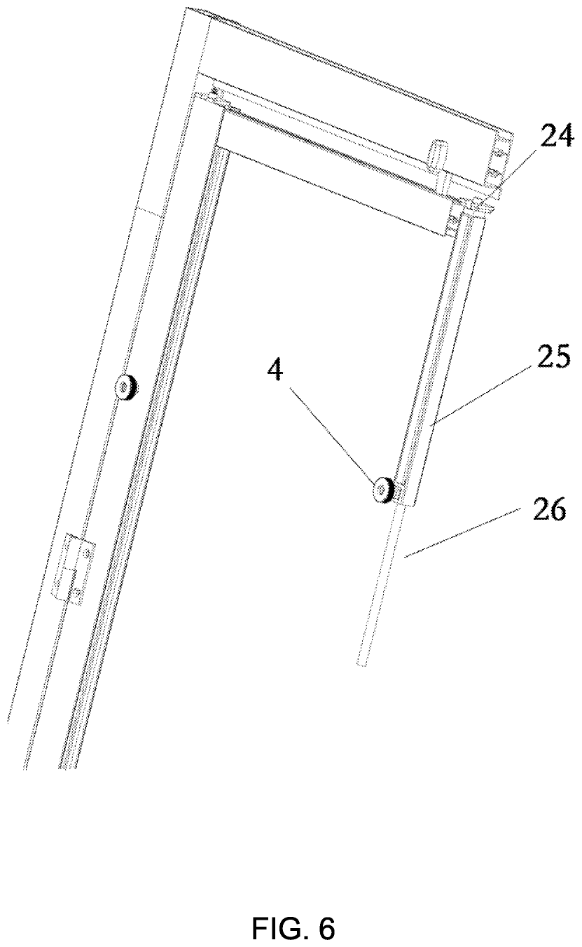

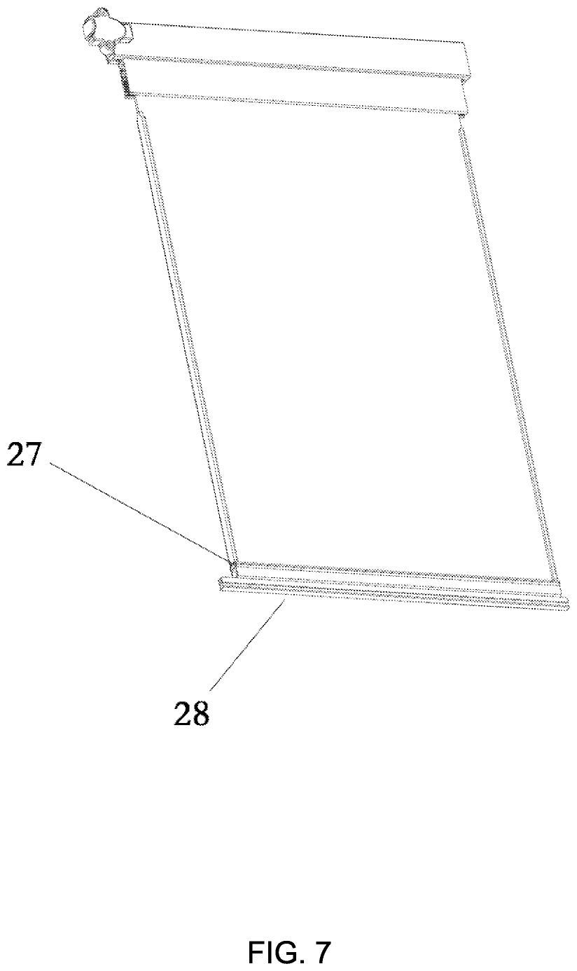

A first embodiment of a double opening pet door is shown in FIGS. 1 to 8. The pet door includes a connection frame 1 and a movable door 10, which are connected by a hinge 13. The movable door 10 is integrated by connecting an upper movable door 3 and a lower movable door 6 through profiles. The upper movable door 3 has a rectangular viewing window 7, and the lower movable door 6 has a square viewing window 7. The upper movable door 3 has an expansion piece 25, a built-in telescopic rod 26, a spring, and a snap spring. Two ends of the telescopic rod 26 extend from the expansion piece 25, and a contact end 24 of the expansion piece 25 contacts the connection frame 1. A height of the telescopic rod 26 can be fixed by locking the knob 4.

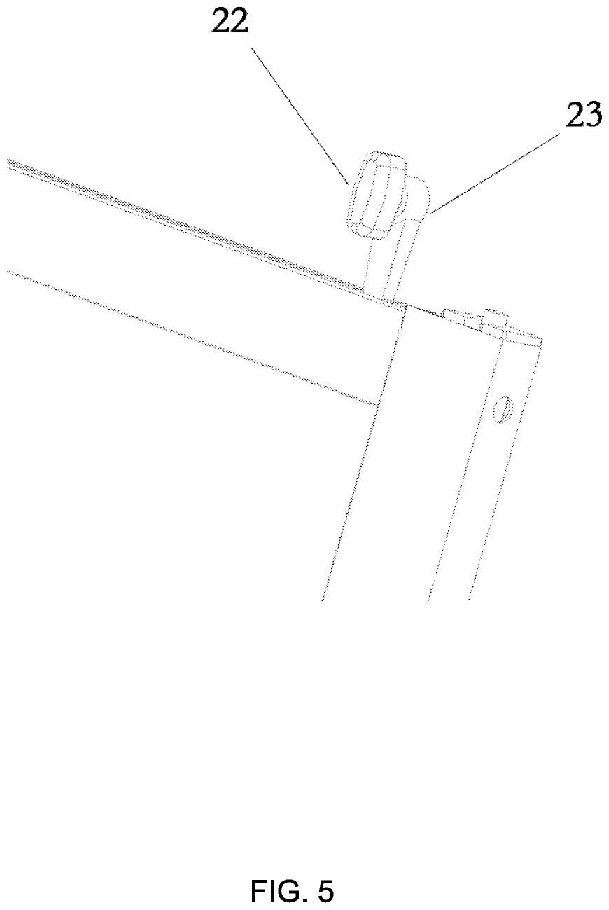

As shown in FIG. 5, upper and lower frames of the connection frame 1 are each provided with locking knobs 22 and locking rods 23. Rotating the locking knobs 22 can insert the locking rods 23 into the movable door profile.

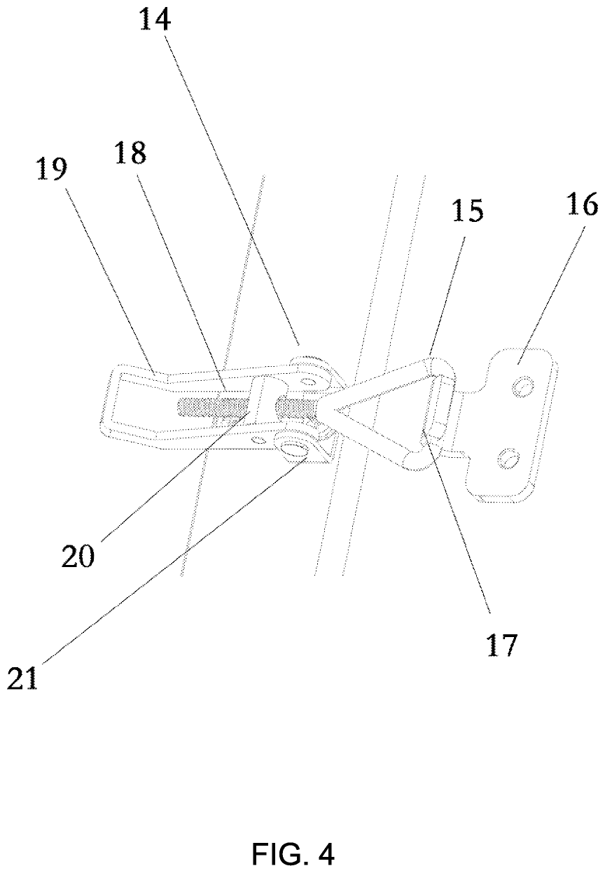

As shown in FIG. 4, an outer side of the upper movable door 3 is connected to a connection movable lock 5, and the connection movable lock 5 includes a lock seat 21. The lock seat 21 is provided with a lock body 14, and the lock body 14 is provided with a push locking position 19. The lock body 14 is provided with a connection screw body 20, and a bolt in the connection screw body 20 is connected to a screw 18, and the screw 18 is provided with a lock head 15.

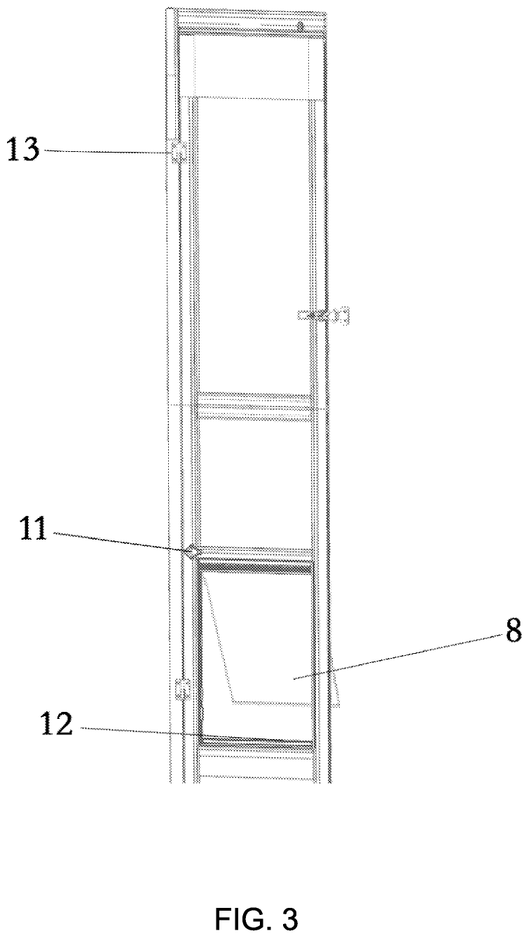

As shown in FIG. 3, the lower movable door 6 is provided with a pet door 8 that can be flipped up and down, and a pet lock pin 11 that can restrict an one-way opening of the pet door 8.

As shown in FIGS. 1 to 6, the connection frame 1 is fixed on the door frame, and the movable door 10 is connected to the connection frame 1 through the hinge 13. Rotate the locking knob 4, adjust the length of the telescopic rod 26, and fix the contact end 24 in place with the connection frame 1.

During daily use, the locking knob 22 is rotated to insert the locking rod 23 into the movable door profile. When connecting with other doors, the push locking position 19 of the connection movable lock 5 is pushed to match the lock head 15 with the locking hook 17. The locking hook 17 is provided on the movable door locking position 16, and the movable door locking position 16 is fixed to other doors. By push locking position 19, the connection screw body 20 is moved to rotate the lock body 14 on the lock seat 21, so that the lock head 15 can be hooked with the locking hook 17. During this process, the length of the screw 18 is adjusted to better fix the connection movable lock 5 with other doors.

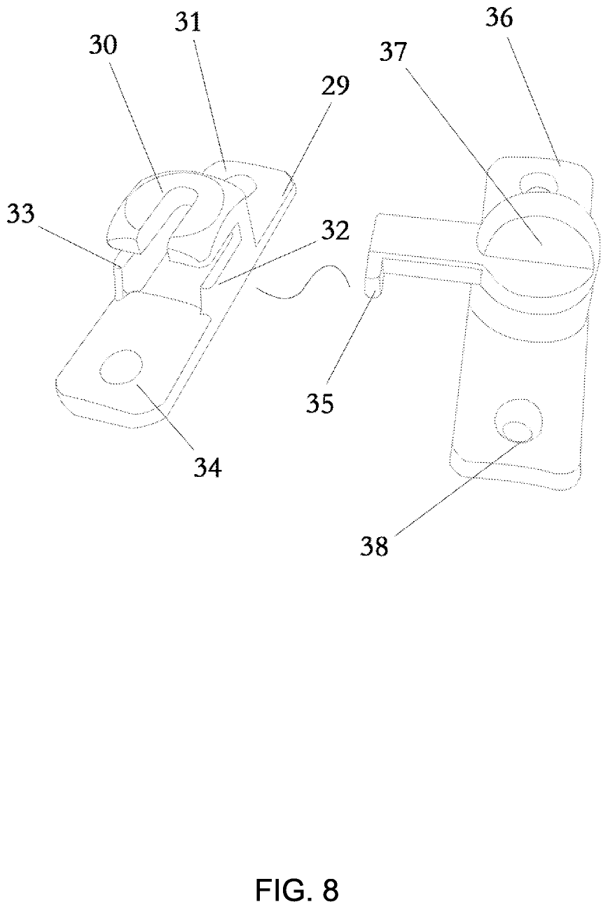

As shown in FIG. 8, there may be some problems with the structure of the connection movable lock 5, such as the problem of different heights or angles when connected to other doors but in contact with the wall or wall corner, which may result in abnormal use. To address this problem, a movable lock structure is proposed, which includes a first fixed seat 29, a first connection hole 34 on the first fixed seat 29, and the first fixed seat 29 is fixed to the movable door 10 through the first connection hole 34. The first fixed seat 29 is provided with a lock core 31, and each surface of the lock core 31 is provided with locking positions, namely a first locking position 30, a second locking position 32, and a third locking position 33. A second fixed seat 36 is provided on a wall or a wall corner. The second fixed seat 36 is provided with a second connection hole 38, and the second fixed seat 36 is fixed to the wall or the wall corner through the second connection hole 38. The second fixed seat 36 is provided with a rotatable head 37 for use. The rotatable head 37 is provided with a rotating locking hook 35, and the rotating locking hook 35 is coupled with the first locking position 30, the second locking position 32, or the third locking position 33 to solve the problem of different heights or angles that prevent normal use.

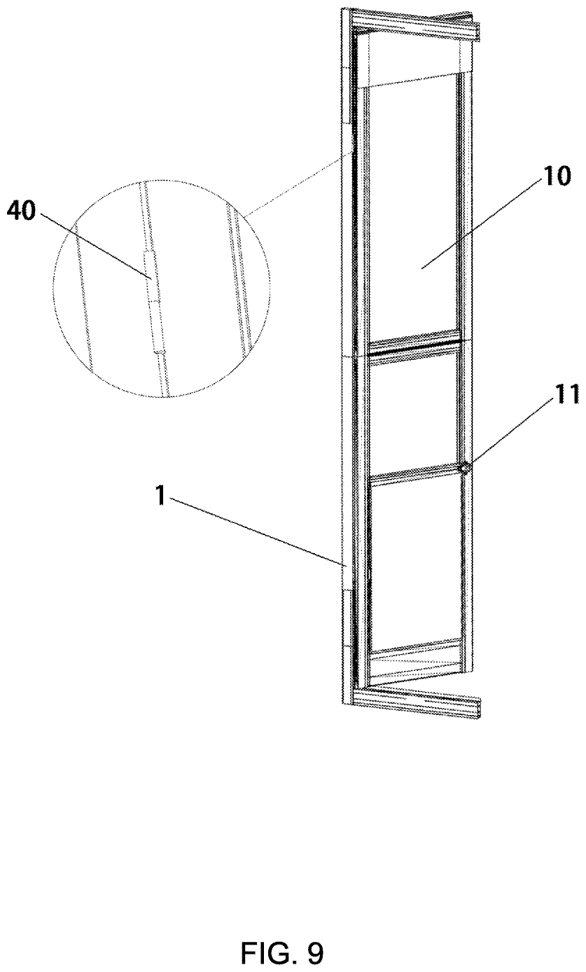

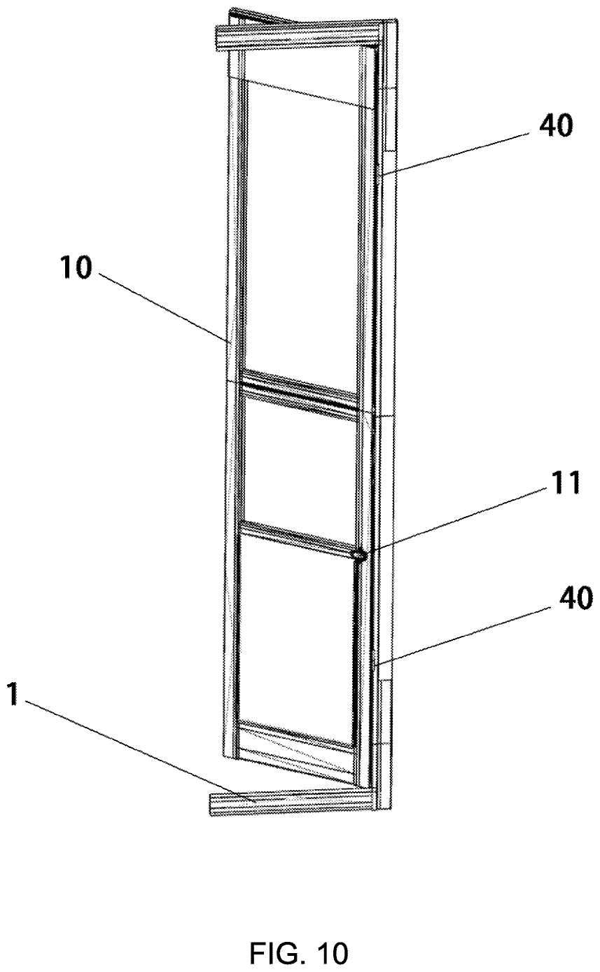

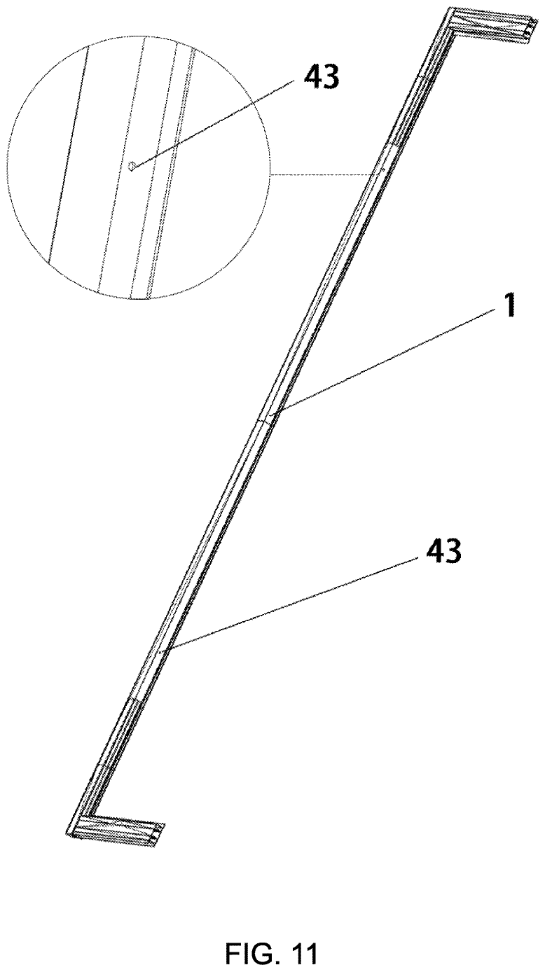

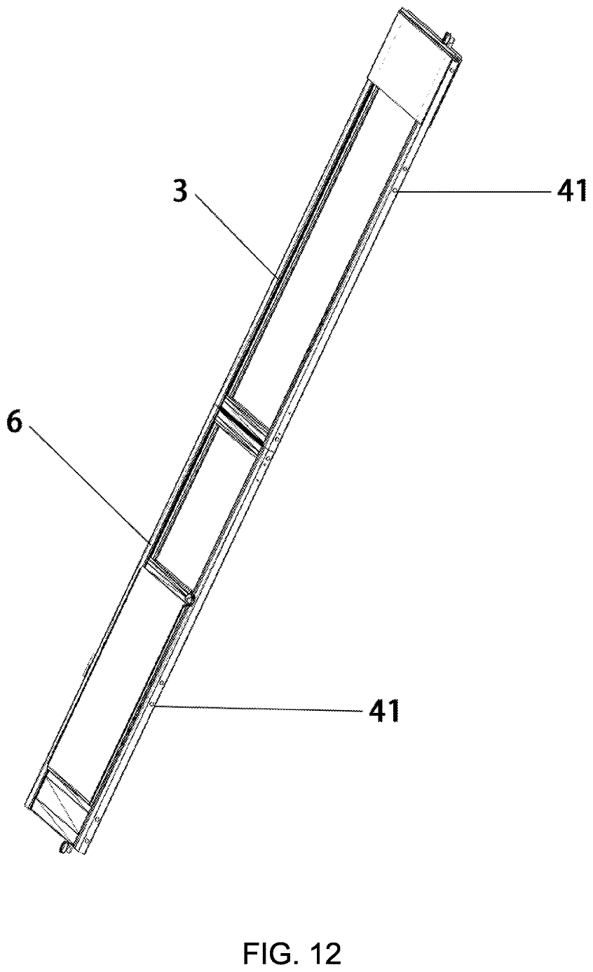

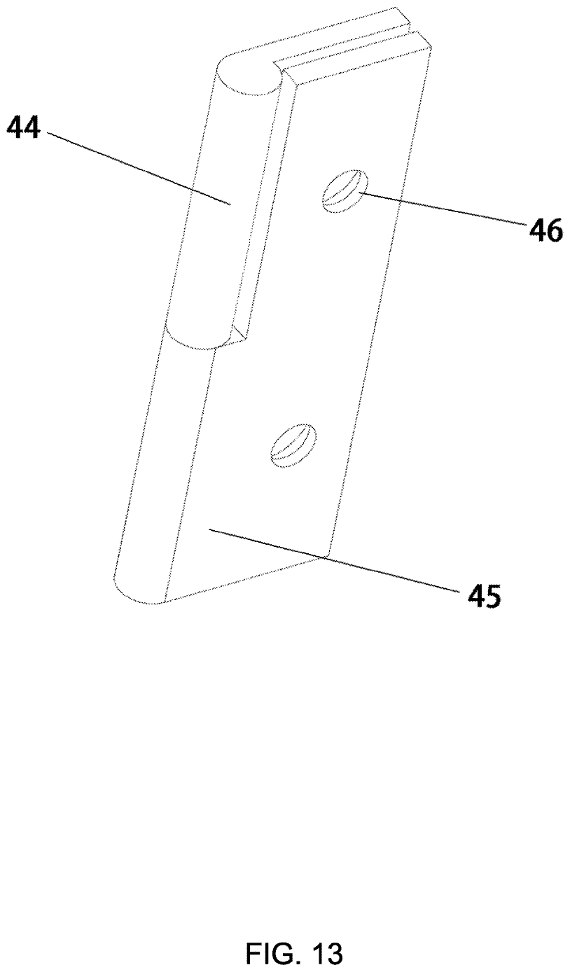

The above-mentioned double opening pet door connection frame 1 and the movable door 10 are connected by the hinge 13. Although the hinge structure can achieve the function of opening the movable door, the opening direction needs to be determined in advance during installation. Therefore, the present disclosure also provides a pet door structure that can be used for both left and right opening doors, and the installation direction is flexible and adjustable. A second embodiment of the double opening pet door is shown in FIGS. 9 to 13.

As shown in FIGS. 9 to 13, the connection frame 1 is connected to the movable door 10 through a pin body 40, and the pin body 40 is composed of an upper pin 44 and a lower pin 45. Both the upper pin 44 and the lower pin 45 are provided with pin holes 46. It is worth noting that in order to enable the movable door 10 to flexibly adjust the installation direction, there are fitting grooves 41 on two sides of the movable door 10, and matting holes 43 are provided at corresponding positions of the fitting grooves 41 on the connection frame 1.

By threading the screw through the pin hole 46 of the upper pin 44 and fixing it on the matching hole 43, a connection between the connection frame 1 and the pin body 40 can be completed. By threading the screw through the pin hole 46 of the lower pin 45 and fixing it on the matching hole 41, the connection between the movable door 10 and the pin body 40 can be completed. When the movable door 10 needs to be used as a left door, simply fix the connection frame 1 on a left side of the door frame, and the pin body 40 is fixed to the matching hole 41 on the left side of the movable door 10 through the screw. When the movable door 10 needs to be used as a right door, the connection frame 1 is simply flipped and it is fixed on the right side of the door frame. At this time, the pin body 40 is fixed to the matching hole 41 on a right side of the movable door 10 through the screw. This structure can be flexibly adjusted to open the door direction, compatible with both left and right door usage modes, eliminating the need to produce products with separate specifications for left and right doors, reducing production costs, and thus simultaneously enhancing the convenience of product usage.

In summary, the present disclosure is only a specific implementation mode, but the protection scope of the present disclosure is not limited to this. Any changes or replacements that can be easily thought of by those skilled in the art within the technical scope disclosed in the present disclosure should be included within the protection scope of the present disclosure. Therefore, the protection scope of the present disclosure should be based on the protection scope of the claims.

What is claimed is:

1. A double opening pet door, comprising: a connection frame, wherein the connection frame is connected to a movable door, and the movable door is provided with a movable pet door; the movable door is further provided with a pet lock pin configured to restrict an opening of the pet door.

2. The double opening pet door according to claim 1, wherein the connection frame is connected to the movable door through a pin body, the connection frame is provided with fitting grooves, and the connection frame is connected to the pin body through the fitting groove;
two sides of the movable door are provided with the fitting grooves, and the pin body cooperates with the fitting grooves to enable the movable door to rotate in two directions and flexibly adjust an installation direction.

3. The double opening pet door according to claim 2, wherein when the movable door is used as a left door, the connection frame is fixed to a left side of the door frame, and the pin body is fixed to the fitting grooves on the left side of the movable door through screws;
when the movable door is used as a right door, the connection frame is fixed to a right side of the door frame, and the pin body is fixed to the fitting grooves on the right side of the movable door through the screws.

4. The double opening pet door according to claim 3, wherein the pin body is composed of an upper pin and a lower pin, and both the upper pin and the lower pin are provided with pin holes;
by threading the screws through the pin hole of the upper pin and fixing it on the matching hole, a connection between the connection frame and the pin body is completed;
by threading the screw through the pin hole of the lower pin and fixing it on the matching hole, the connection between the movable door and the pin body is completed.

5. The double opening pet door according to claim 1, wherein the movable door is provided with a height adjustment system, and the height adjustment system comprises an expansion piece, and the expansion piece is provided with a telescopic rod, a spring, and a snap spring inside; two ends of the telescopic rod extend from the expansion piece and is fixed by a locking knob.

6. The double opening pet door according to claim 5, wherein the expansion piece is provided with a contact end, and when the contact end contacts with the connection frame, the telescopic rod abuts against the connection frame;
when the telescopic rod is too long, the connection frame presses down on the telescopic rod, and the telescopic rod compresses the spring to adapt to a height of the connection frame;
a required height of the telescopic rod is determined by pressing the locking knob against the telescopic rod.

7. The double opening pet door according to claim 1, wherein upper and lower frames of the connection frame are each provided with locking knobs and locking rods, and rotating the locking knobs enables the locking rods to insert to the movable door profile;
the movable door is formed by connecting the upper and lower movable doors through profiles, and both the upper and lower movable doors are provided with visual windows.

8. The double opening pet door according to claim 1, wherein the movable door is provided with a connection movable lock.

9. The double opening pet door according to claim 8, wherein the connection movable lock comprises a lock seat, a lock body is provided on the lock seat, a push locking position is provided on the lock body, and a connection screw body is provided on the lock body;
a bolt in the connection screw body is connected to a screw, and the screw is provided with a lock head;
the lock head is matched with a locking hook, and the locking hook is provided on the movable door locking position, the movable door locking position is fixed on other doors;
when in use, the push locking position drives the connection screw body to move, so that the lock body rotates on the lock seat, and the lock head is configured to cooperate with the locking hook;
during this period, a length of the screw is adjusted to fix the connection movable lock and other doors.

10. The double opening pet door according to claim 8, wherein the connection movable lock comprises a first fixed seat, and the first fixed seat is provided with a first connection hole, and the first fixed seat is fixed to the movable door through the first connection hole;
the first fixed seat is provided with a lock core, and each surface of the lock core is provided with locking positions, namely a first locking position, a second locking position, and a third locking position;
a second fixed seat is provided on a wall or a wall corner, and the second fixed seat is provided with a second connection hole;
the second fixed seat is fixed to the wall or wall corner through the second connection hole;
the second fixed seat is provided with a rotatable head, and the rotatable head is provided with a rotating locking hook, and the locking hook is coupled with the first locking position, the second locking position, or the third locking position.
